(19) United States
(12) Patent Application Publication
(10) Pub. No.: US 2011/0047085 A1
(43) Pub. Date: Feb. 24, 2011

(54) Method and system for minimizing the risks associated with printing and affixing intellectual property indicia upon a commercial ready product

(76) Inventor: Nancy Ottosen, Yorkville, IL (US)

Correspondence Address: MCHALE & SLAVIN, P.A., 2855 PGA BLVD, PALM BEACH GARDENS, FL, 33410, US

(21) Appl. No.: 12/914,684

(22) Filed: Oct. 28, 2010

(51) Int. Cl. G06Q 50/00

(52) U.S. Cl. 705/310

(57) ABSTRACT

The instant invention relates to a method and system for addressing the increasing risk of litigation and huge payouts that patent holders face with regards to marking of intellectual property indicia, particularly patent markings, upon a commercial ready product. For companies that maintain large patent portfolios and/or produce large numbers of products, the methods and systems in accordance with the instant invention provide assurance that the company can obtain the benefits of patent marking while not becoming the subject of quick payout seeking plaintiffs. Moreover, the methods and systems of the instant invention can be used to harmonize the company's efforts of compliance of the false marking statutes. The system generally includes one or more databases containing one or more intellectual property status related data factors associated with one or more commercial ready products, at least one programmable device that receives, stores, manipulates, and outputs data and is coupled with one or more database, and a printer in operable connection with the at least one programmable device for printing the intellectual property indicia.

### FIELD OF THE INVENTION

The present invention generally relates to a method and system of reducing the risk associated with marking a product with intellectual property indicators, and more particularly computer implemented methods and systems which analyze intellectual property status-related factors compiled in at least one database to determine the type of intellectual property indicia which may be placed upon or associated with one or more products prior to such products being placed within the channels of commerce.

### BACKGROUND OF THE INVENTION

Intellectual property traditionally defines various types of legal protections afforded to intellectual property holders, such as individual inventors, start-up companies, and multi-national corporations, in the areas of patents, trademarks, copyrights, and trade secrets. While such definition remains true today, the concept of intellectual property has expanded. In addition to protecting a company's brand name, goodwill, or product lines, protection of such items under the law additionally includes know-how and methods of doing business. Moreover, in an ever expanding global economy, developing and protecting complex intellectual property portfolios is a vital aspect of any commercial strategy. Such portfolios protect current and future assets, provide leverage for revenue generating sources, and minimize exposure a company may face as a result of alleged infringing actions brought against a company, which may require the company to cease selling a product or service.

One particular area of intellectual property which has expanded, not only in its use but also in development of legal protections afforded, over the last decade is patents. Patent law is the primary policy tool to protect products, processes, manufacture, or compositions of matter. Such legal protection finds authority in the United Sates Constitution and is defined generally by The Patent Act of 1952 (35 U.S.C) and its interpretation by the federal court system. Common benefits associated with the patent system include stimulation of innovation, encouragement of investments in research and development, and encouragement of public disclosure. Upon satisfying all legal requirements, the patent owner is then afforded patent protection. Obtaining patent protection is beneficial to a patent holder, allowing the patentee the right to exclude others from making, using, selling, offering to sell and importing into the United Sates the patented invention, as well as an ability to recover monetary damages from infringers. While the patent owner enjoys such legal rights, it is the patentee that bears the responsibility for monitoring competitors to detect infringement. Therefore, while the United States Patent Office is responsible for the initial determination of patentability, and the United States patent laws prohibit use of the patented invention without the patentee's consent, the patent owner shoulders the burden of monitoring and enforcement.

Typical infringement suits, if successful, provide several benefits to the patent owner. First, the validity of the patent and the claim coverage is often confirmed. For those products found to be infringing, such lawsuit prevents future infringement. The patent owner may also be monetarily compensated for the infringing actions. The amount collected can be based on varying factors, one of which is compliance with 35 U.S.C. 287. Patentees selling products covered by a U.S. patent or patent application are advised by patent attorneys to mark their products using appropriate language. Marking products under the United States Patent Act provides patentees the right to place the phrase “patent or pat.” along with the patent number directly on their product. For products which can not be directly marked, the statute states that affixing such information to a label placed on the product or product packaging is acceptable. Marking provides constructive notice to the public that the product is covered by a U.S. patent, which affords the patentee the opportunity to maximize the amount of damages recoverable in litigation. In the event that the patentee does not provide a mark, no damages will be recovered by the patentee in any action of infringement, except where the patentee can offer proof that the infringer was notified of the infringement and continued to infringe after such notice. In such a case, however, damages are linked to infringing acts which occur after notice. Requiring products to be properly marked also provides a benefit to the public. Members of the public are easily placed on notice that the product that they might want to use or copy is proprietary and protected. One need not engage in lengthy investigation to determine if and what parts of the product is covered by a patent, and is therefore free to spend limited resources developing improvements or design around products.

Clearly it is beneficial to the patent holder to mark their products as early as possible. Placing patent indicia, such as patent status or the actual patent number, therefore is a necessary, although not mandatory, action that the patent owner must undertake to receive the maximum compensation in an infringement action. In addition to laws covering how patents may be marked, United States Patent Laws cover false patent marking. A person can be subject to suit under 35 U.S.C. 292 if that person, with the intent to counterfeit or deceive the public and without a patentee's consent, marks their own product with the patentee's patent number. Additionally, with intent to deceive the public, a patentee who marks his/her own product, including marketing materials, brochures, advertisements, websites, or the like, with either “patent” or “patent pending” (or similar language), when the product is not patented or covered under a pending application may be held liable under Section 292 as well. Federal Courts have interpreted the statute to cover products that are marked with expired patents. Penalties for undertaking such actions can result in fines of up to $500.00 for each offense. While the true costs to the public as a result of false marking has been debated, it has been alleged that acts of false marking deter innovation and stifle competition in the market place, cause unnecessary costs associated with investigating and analyzing the validly and enforceability of false marked products, and may even result in causing consumers to pay artificially higher prices for the product. So, while marking products with a patent number is a vital aspect of enforcement, improperly marking products has the potential to expose the patent owner to hefty fines and the costs of defending false marking allegations.

Prior to January 2010, lawsuits under 35 USC 292 for false marking where traditionally brought under actions in which the marked product was not covered by any patent. However, recent clarification by the Federal Courts regarding who can bring suit under 35 USC 292 has exposed the patent owner to the possibility of litigation. 35 USC 292 is unique in that any person may file a lawsuit and have standing as a Qui Tam Relator (a private person authorized to bring a suit on behalf of the government for which the person shares in the financial recovery). The Qui Tam standing in effect exposes patent owners to an unlimited number of potential lawsuit-seeking plaintiffs in jurisdictions all over the country. Moreover, the statute allows for a penalty of $500.00 per each falsely marked product. These two aspects of the false marking statue has created a new cottage industry of companies established for the sole purpose of filing lawsuits against patent owners or licensees that mark their products with expired patent numbers.

Companies wishing to avoid exposure to litigation, hefty fines, or forced settlements to avoid litigation from plaintiffs seeking quick payouts are advised to set up patent marking systems which can track, analyze and monitor new or existing products that are/will be covered by a patent. For companies that mass produce products, patent marking is typically accomplished by including the patent number as part of the die casting, which effectively engraves the patent number onto the products as they are made. Replacing all die castings that contain the patent number can be a costly and time consuming undertaking. The numerous personnel responsible for overseeing patent marking can be diverse, making it difficult to ensure that the correct information is received by the proper personnel to effectively prevent litigation actions. Such a system, therefore, is vital, particularly for companies who have large patent portfolios and mass produce products. Systems which are in place may reduce the number of products which may improperly be marked, reduce the costs involved in removing expired patent numbers from newly manufactured products, and can be used to show a lack of intent to deceive the public, thereby avoiding litigation payouts.

### DESCRIPTION OF THE PRIOR ART

Various systems and methods of analyzing intellectual property are known in the prior art. For example, U.S. Pat. No. 5,999,907 discloses an intellectual property computer-implemented audit system for valuing an intellectual property portfolio. The system is described as having a first database which stores information relating to the intellectual property portfolio. A database access and collection device is connected to the database for access to the first database and retrieval of the information. In addition, the intellectual property audit system includes a second database for storing empirical data relating to known intellectual property portfolios, and a comparison device connected to the database access and collection device and to the second database. The comparison device receives the information from the database access and collection device and compares the information to the empirical data retrieved from the second database, thus producing an intellectual property worth indicator indicating the worth of the intellectual property portfolio.

U.S. Pat. No. 6,897,990 discloses a system for identifying potential licensees of a source patent portfolio. The system includes generation of a list of potential licensees of a patent portfolio which can be generated from a source patent portfolio. To identify the licensees, the source patent portfolio comprising, for example, all the patents owned by a particular entity, can be created. A list of a set of patents that are related to or associated with the patents in the source patent portfolio is generated. The unlicensed assignees of patents in this set of related patents are organized according to various criteria. For example, the assignees could be ranked based on the ratio of total patents held by an assignee to the number of patents in the set of associated patents held by that assignee. Such rankings can provide an indication of assignees that may be potential licensees of the patents in the source patent portfolio.

U.S. Pat. No. 7,089,192 discloses an intellectual property management facility for proactively creating, developing and managing an intellectual property portfolio. The method includes the steps of: determining available resource capacity for an intellectual property activity in a tracking system; assigning technical attributes to the activity in the tracking system; apportioning resource capacity for the activity by technical attribute based on the value assigned to each of the technical attributes and based on available resource capacity; obtaining actual resource usage by technical attribute from the tracking system; and managing resource allocation for the intellectual property activity by determining the difference between the actual resource usage and the resource allocation by technical attribute.

U.S. Pat. No. 7,127,405 discloses systems and methods for intellectual property asset selection and protection. The system includes an intellectual property selection system which receives from an innovator an innovation submission describing an innovation. The intellectual property protection system receives at least a portion of the innovation submission and manages obtaining an intellectual property legal right related to the innovation. An intellectual property asset management system receives and stores at least one of an innovation description and an intellectual property legal right description, where the innovation description is based at least in part on the at least a portion of the innovation submission, and the intellectual property legal right description is based at least in part on the intellectual property legal right.

U.S. Pat. No. 7,493,262 discloses a computer based system and method for calculating the value of a license for an intellectual property asset between a licensor and a licensee based on the licensor and licensee investment in the license, as well as the predicted increase in product value due to the change in competitive advantage afforded by the intellectual property asset that is the subject of the license. The value of the license may be discounted to adjust for various risks, or adjusted based on whether the license is exclusive, limited exclusive, or non-exclusive. The system and method is described to calculate an equal return payment which represents the value of either a one-time, lump-sum payment or the present value of a royalty stream distributed over the lifetime of the intellectual property asset, the system and method of the present invention can place a discrete monetary value on an intellectual property asset.

U.S. Pat. No. 7,676,375 discloses a computer system for implementing a macro economic model based upon macroeconomic data and relative value characteristics data of patents that determines nominal values for (1) goods and services and (2) profits generated by sales that are covered by the rights of a patent, implements an income value theory to value the patent based upon the predicted values of profits or goods and services covered by the patent, determines patent terms from patent filing, publication, and issue dates, determines patent assignees from patent data, and uses the value of a company's patents, the patent issuance data and term date data, to determine trends versus time in: the number of a company's enforceable patents; the number of a company's patents obtained; the nominal value of net earnings and of goods and services sold that are covered by the company's patents; the nominal value of the sum of the company's patents, and provides comparisons of those trends between companies, regions, and economic sectors, providing the results of the analysis to users of the computer system. The computer system employs a user database enabling a novel electronic accounting model enabling payment by affiliates, programmed securities trading, and accrediting of investors.

U.S. Pat. No. 7,716,103 discloses a computer assisted method of performing an intellectual property (IP) audit to estimate a value of an intellectual property portfolio. The computer assisted method includes the steps of analyzing the IP portfolio, and deriving first information responsive to said analyzing step based upon the IP portfolio. The computer assisted method also includes the steps of retrieving empirical data relating to known IP portfolios, and comparing the first information to the empirical data, producing an IP worth indicator indicating an estimated worth of the IP portfolio.

U.S. Pat. No. 7,797,253 discloses methods and systems for intellectual property management. In a described embodiment, the system includes an intellectual property asset inventory system to manage an inventory of intellectual property assets. A product inventory system manages an inventory of products, where the inventory of products correspond to a plurality of products and one or more of the products of the plurality of products are associated with one or more of the intellectual property assets of the plurality of intellectual property assets. A marketing management system manages a plurality of marketing projects, where one or more of the marketing projects of the plurality of marketing projects are associated with at least one of (i) one or more products of the plurality of products, and (ii) one or more intellectual property assets of the plurality of intellectual property assets.

### SUMMARY OF THE INVENTION

The instant invention relates to a method and system for addressing the increased risk of litigation and huge payouts that intellectual property holders face with regards to marking of commercial ready products. For companies that maintain large patent portfolios and/or produce large numbers of products, the methods and systems, in accordance with the instant invention, provide assurance that the company can obtain the benefits of patent marking while not becoming the target of quick payout seeking plaintiffs. Moreover, the methods and systems of the instant invention can be used to harmonize the company's compliance of the false marking statutes efforts. Large companies, for example, tend to have several business divisions which are responsible for intellectual property related matters, including upper management, legal counsel, intellectual property managers, and managers overseeing the actual manufacture of the product. When a decision is made that may have an effect on compliance with the patent marking statutes, not all divisions may be aware of the decision, thus increasing the risk of litigation. For example, senior management may decide not to pay the maintenance fee of a particular patent. Such decision may not be filtered down to the managers responsible for manufacturing the product, and as a result the manufacturing process may continue to manufacture products containing the patent marking. This action would subject the company to possible litigation. Moreover, such methods and systems may be used by intellectual property holders who have been sued under the false marking statute as proof that there was no intent to deceive the public, a necessary element in a false marking case.

The method for determining the type of intellectual property indicia to be printed onto a commercial ready product prior to entry of the product within the channels of commerce, in accordance with the instant invention, comprise the steps of obtaining a commercial ready product which requires a determination if one or more intellectual property indicia should be affixed thereupon; retrieving intellectual property information regarding the commercial ready product from at least one database which houses one or more factors related to the status of the intellectual property connected to the commercial ready product; determining what intellectual property indicia should be printed and affixed to the commercial ready product; printing the intellectual property indicia relating to the commercial ready product; and affixing, associating, or combinations thereof, the printed intellectual property indicia to the commercial ready product. The method for determining the type of intellectual property indicia to be printed onto a commercial ready product prior to entry of said product within the channels of commerce, therefore, minimizes the risks associated with marking said commercial ready product with said intellectual property indicia.

In an alternative embodiment, the method for determining the type of intellectual property indicia to be printed onto a commercial ready product prior to entry of the product within the channels of commerce, comprises the steps of: creating at least one database containing intellectual property information effective for determining the type of intellectual property indicia which may be required to be affixed to or associated with one or more commercial ready products prior to entering the channels of commerce; coupling the at least one database to at least one programmable device that receives, stores, manipulates, and outputs data; identifying one or more commercial ready products which requires a determination if one or more intellectual property indicia should be affixed thereupon; retrieving the intellectual property information regarding the commercial ready product from the at least one database; determining what intellectual property indicia should be printed, affixed, or connected to the commercial ready product, the determination including a computer generated software analysis of the intellectual property information stored in the at least one database; printing the intellectual property indicia to the commercial ready product, and affixing, associating, or combinations thereof, the said printed intellectual property indicia to the commercial ready product. A second database, which is coupled to the first database and/or the programmable device operated and maintained by a third party and contains intellectual property information relating to a plurality of intellectual property holders, may be utilized. The method for determining the type of intellectual property indicia to be printed onto a commercial ready product prior to entry of the product within the channels of commerce, therefore, minimizes the risks associated with marking said commercial ready product with said intellectual property indicia.

The instant invention also includes a system for determining the type of intellectual property indicia to be printed onto a commercial ready product prior to entry of the product within the channels of commerce. The system comprises a first database containing one or more intellectual property status related data factors associated with one or more commercial ready products. At least one programmable device that receives, stores, manipulates, and outputs data is coupled to the first database. The programmable device is capable of accessing the first database and retrieving the intellectual property information regarding one or more items. The at least one programmable device further contains a computer executable software having a code stored on a readable medium which is operable with the first database. The software is capable of processing the intellectual property information in a particular manner and determining what intellectual property indicia should be printed and associated with the one or more commercial ready products prior to such products entering the channels of commerce. The system further includes a printer in operable connection with the at least one programmable device and capable of receiving and processing a command from the software for processing the intellectual property information in a particular manner to print the intellectual property indicia related to one or more commercial ready products. The system for determining the type of intellectual property indicia to be printed onto a commercial ready product prior to entry of the product within the channels of commerce, therefore, minimizes the risks associated with marking the commercial ready product with the intellectual property indicia. The system may also contain a second database which is coupled to the first database and/or the programmable device. The second database is operated and maintained by a third party and contains intellectual property information relating to a plurality of intellectual property holders.

As used herein, the term “commercial ready product” is defined as any product or item that has been manufactured or will be manufactured.

As used herein the term “channels of commerce” include all avenues of domestic and international aspects of trade and business, including those avenues in which the product has been shipped to a wholesaler, commercial vendor, and end user, as well as products that have been manufactured, but have not reached the end user, such as those products which remain in the companies warehouse prior to shipping to a wholesaler, commercial vendor, or end user.

Accordingly, it is an objective of the instant invention to provide a method for printing intellectual property indicia upon a commercial ready product.

It is a further objective of the instant invention to provide a method for reducing the risk associated with intellectual property marking.

It is yet another objective of the instant invention to provide a method for minimizing a patent owner's exposure to litigation based under the false marking statue, 35 U.S.C. 292.

It is a still further objective of the invention to provide a method for printing intellectual property indicia upon a commercial ready product, thereby reducing the risks associated with improperly marking a commercial ready product which includes at least one database containing information relating to a patent portfolio.

It is a further objective of the instant invention to provide a method for printing intellectual property indicia upon a commercial ready product, thereby reducing the risks associated with improperly marking the commercial ready product which includes at least one database containing patent status-related factors concerning a patent portfolio.

It is a still further objective of the instant invention to provide a method for printing intellectual property indicia upon a commercial ready product which uses an internal database storing intellectual property information relating specifically to the company's intellectual property portfolio.

It is yet another objective of the instant invention to provide a method for printing intellectual property indicia upon a commercial ready product in which the database is created and/or maintained by a third party, and storing intellectual property information relating to a plurality of intellectual property holders.

It is further objectives of the instant invention to provide a method for printing intellectual property indicia upon a commercial ready product in which the patent status-related factors include, product identification, patent number, patent application number, patent status, expiration date of patent, maintenance fee history data, modification data, or combinations thereof.

It is a further objective of the instant invention to provide a method for printing intellectual property indicia upon a commercial ready product which provides the patent owner the ability to overcome allegations that the patent owner had specific intent to deceive the public by falsely marking a product.

It is yet another objective of the instant invention to provide a system of printing intellectual property indicia upon a commercial ready product.

It is a still further objective of the invention to provide a system for reducing the risk associated with intellectual property marking.

It is yet another objective of the instant invention to provide a system for minimizing a patent owner's exposure to litigation based under the false marking statue, 35 U.S.C. 292.

It is a still further objective of the invention to provide a system for printing intellectual property indicia upon a commercial ready product, thereby reducing the risks associated with improperly marking a commercial ready product which includes at least one database containing information relating to a patent portfolio.

It is a further objective of the instant invention to provide a system for printing intellectual property indicia upon a commercial ready product which uses an internal database storing intellectual property information relating specifically to the company's intellectual property portfolio.

It is yet another objective of the instant invention to provide a system for printing intellectual property indicia upon a commercial ready product in which the database is created and/or maintained by a third party, and storing intellectual property information relating to a plurality of intellectual property holders.

It is a still further objective of the invention to provide a system for printing intellectual property indicia upon a commercial ready product, thereby reducing the risks associated with improperly marking the commercial ready product which includes at least one database containing patent status-related factors concerning a patent portfolio.

It is further objectives of the instant invention to provide a system of printing intellectual property indicia upon a commercial ready product in which the patent status-related factors include product identification data, patent number, patent application number, patent status, expiration date of patent, maintenance fee history data, modification data, or combinations thereof.

It is yet another objective of the instant invention to provide a system for printing intellectual property indicia upon a commercial ready product which provides the patent owner the ability to overcome allegations that the patent owner had specific intent to deceive the public by falsely marking a product.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a pictorial overview of a system for determining the type of intellectual property indicia to be printed onto a commercial ready product prior to entry of the product within the channels of commerce in accordance with the present invention;

FIG. 2 is a flowchart of the operation of the system shown in FIG. 1;

FIG. 3 illustrates a database containing intellectual property status-related factors in accordance with the instant invention;

FIG. 4 depicts a single database entry related to a specific commercial ready product in accordance with the instant invention;

FIG. 5 depicts a user product database containing intellectual property status-related data factors related to a plurality of commercial ready products in accordance with the instant invention;

FIG. 6 is an illustrative example of a representative intellectual property status-related data factor, a status identifier, in accordance with the instant invention;

FIG. 7 is an illustrative example of a representative intellectual property status-related data factor, the payment history, in accordance with the instant invention;

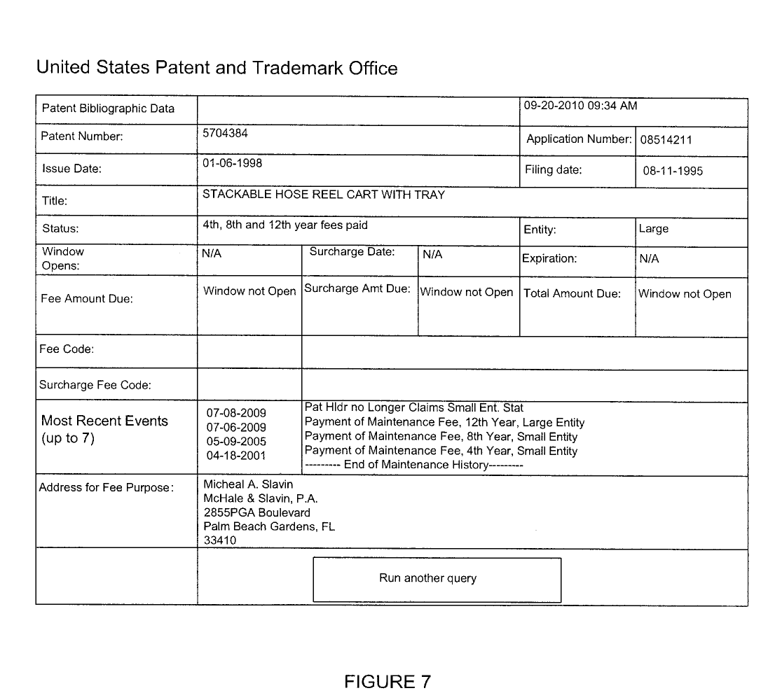

FIG. 8 is an illustrative example of the printed intellectual property indicia in accordance with the instant invention;

FIG. 9 is an illustrative example of the printed intellectual property indicia, in combination with an optical product identifier, in accordance with the instant invention;

FIG. 10 is an illustrative example of a plurality of printed intellectual property indicia, in combination with an optical product identifier, in accordance with the instant invention.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

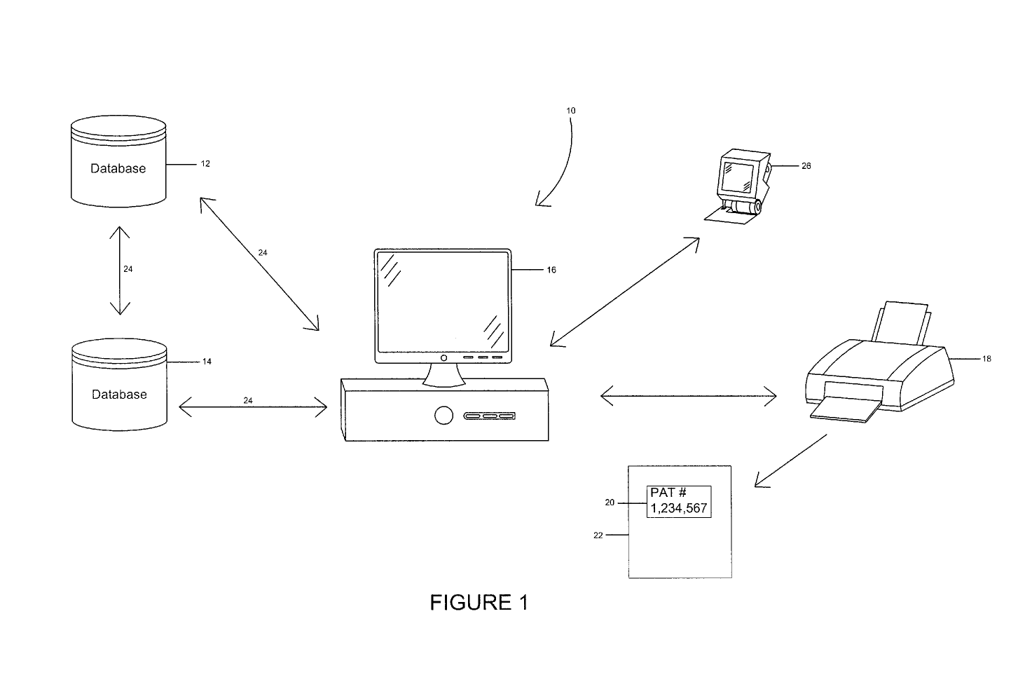

Referring to FIG. 1, a system 10 for determining the type of intellectual property indicia to be printed onto a commercial ready product prior to entry of the product within the channels of commerce is shown. The system 10 includes one or more databases 12 and 14 containing intellectual property information effective for determining the type of intellectual property indicia required to be affixed to or associated with one or more commercial ready products prior to entering the channels of commerce. The one or more databases 12 and 14 are coupled to at least one programmable device, illustrated herein as a computer terminal 16 that receives, stores, manipulates, and outputs data, and is capable of accessing the databases 12 and/or 14 and retrieving the intellectual property information. Databases 12 and 14 may additionally be coupled to each other. The computer terminal 16 further contains a computer executable software having a code stored on a readable medium which is operable with the databases 12 and 14 and provides for processing of the intellectual property information in a programmed manner to determine what intellectual property indicia should be printed and associated with one or more commercial ready products prior to said products entering the channels of commerce. The system 10 also contains printing device 18 in operable connection with the at least one computer terminal 16 and is capable of receiving and processing a command from the software for processing the intellectual property information in a particular manner to print intellectual property indicia 20 related to one or more commercial ready products 22.

The computer terminal 16 generally contains at least one central processing unit (CPU), a main storage, and one or more input/output devices. As is well known in the art, the central processing unit is the control center of the computer terminal 16 and provides the sequencing and processing facilities for instruction, execution, interruption action, timing functions, initial program loading and other machine related functions. The central processing unit executes at least one operating system, which as known, is used to control the operation of the computing unit by controlling the execution of other programs, controlling communication with peripheral devices, and controlling use of the computer resources. The central processing unit is coupled to the main storage, which is directly addressable and provides for high speed processing of data by the central processing unit. The main storage may be either physically integrated with the CPU or constructed in stand alone units. The main storage is also coupled to one or more local or remote input/output devices. These devices may include, for example, keyboards, communications controllers, teleprocessing devices, printers, direct access storage devices, and sensor based equipment. Data is transferred from the main storage to the input/output devices, and from the input/output devices back to the main storage. Although the system 10 is illustrated with one computer terminal 16, the one or more databases 12 and 14 may be accessed using a plurality of computer terminals. The databases 12 and 14 may be stored within the main storage of the computer terminal 16, or alternatively, may be stored remotely, such as on other computer terminals, or more preferably, on remote servers.

To access the remotely stored databases, the system 10 includes a communication network 24, such as, but not limited to, the internet, a local area network (LAN), or a wide area network (WAN) which allows the programmable device 16, i.e. computer terminal, access to the information stored within the remote database 12 or 14. Communication between the databases 12 and 14 and the computer terminal 16 through the communication network 24 may occur via hardware connections such as serial ports, wireless transmission modes, or combinations thereof. The system 10 may optionally include an optical reader device 26, defined herein as any device that captures visual information and translates the image captured into digital information that can be understood and utilized by a computer system. In a preferred embodiment, the optical reader device 26 is a scanning device that reads text in lines, such as a bar code (optical machine-readable representation of data) reader, including, but not limited to, a pen wand, a slot scanner, a CCD scanner, or a laser scanner. The bar code reader can be directly attached to the system using appropriate hardware, or, alternatively may be remotely connected through use of wireless communications or other communication networks. Use of a bar code reader is illustrative only, and other devices which are known to one of skill in the art which are capable of reading information and translating the image captured into digital information, such that the encoded article can be scanned to provide information, can be used as well.

The databases 12 and 14 are arranged to primarily contain intellectual property information. While such databases may contain intellectual property relating to copyrights, trademarks, and trade secrets, a preferred embodiment contains patent related information. The databases may be developed to contain information developed by a specific intellectual property holder and contain only intellectual property specifically related to their patent portfolio (referred to also as an internal database). The intellectual property information may include patent status-related data factors, including: an internal identification number associated with the patented product, a product description, the issued patent number, the patent application serial number, the status of the patent application or issued patent, the expiration date of the issued patent, the fee history status, description of any commercial modifications made to the patented product, litigations relating to the patented product, and information relating to foreign filing or granted patents. Such information may be manually entered into a computer database to create a searchable computer document, i.e. Microsoft Excel, or may be compiled by software programs designed to retrieve the information from an independent source and merge the retrieved data into a single database. In addition to, or in lieu of, the database stored on the computer terminal 16, the internally created database may be stored within a remote server or other computer terminals.

A second database may be used to obtain additional patent information, update the intellectual property information stored in the first, internally generated database, and/or be utilized as a primary database. The second database (also referred to as an external database) is housed remotely from the first internal database and is maintained and operated by a third party, such as by a governmental agency, i.e. the United States Patent & Trademark Office, the Canadian Patent Office, or a private company's proprietary database, such as DELPHION's intellectual property network patent database, LEXIS NEXUS databases, or litigation database services such as DOCKET NAVIGATOR. The intellectual property information stored on the external databases corresponds to a plurality of intellectual property holders and not just to a single, specific intellectual property holder.

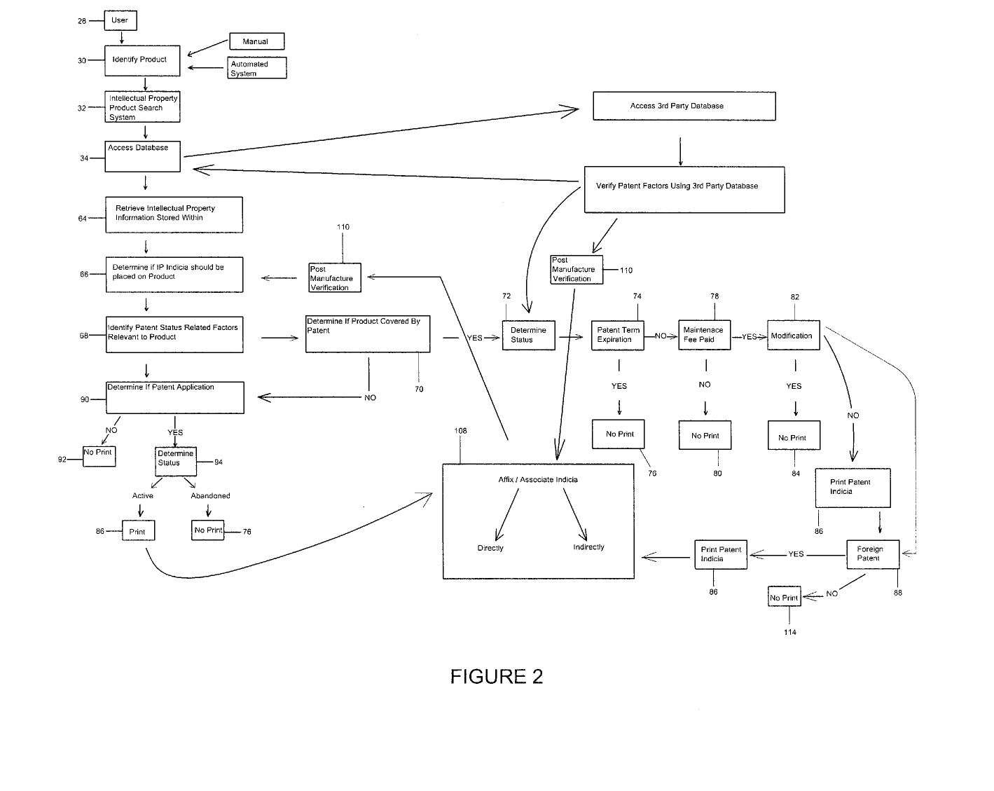

Referring to FIG. 2, a preferable operational scheme is illustrated and includes the steps of: 1) creating at least one database containing intellectual property information effective for determining the type of intellectual property indicia required to be affixed to or associated with one or more commercial ready products prior to entering the channels of commerce, 2) coupling the at least one database to at least one programmable device that receives, stores, manipulates, and outputs data; 3) identifying, obtaining, and/or providing one or more commercial ready products which requires a determination if one or more intellectual property indicia should be affixed thereupon; 4) retrieving the intellectual property information regarding the commercial ready product from the at least one database; 5) determining what intellectual property indicia should be printed, affixed, or connected to the commercial ready product, the determination including a computer generated software analysis of the intellectual property information stored in said at least one database; 6) printing the intellectual property indicia to the commercial ready product, and 7) affixing, associating, or combinations thereof, the printed intellectual property indicia to the commercial ready product. The flow diagram depicted herein is provided as illustrative only. There may be variations to these diagrams or the steps (or operations) described herein without departing from the spirit of the invention. For example, the steps maybe be performed in deferring order, or steps may be added, deleted, or modified. All of these variations are considered to comprise part of the instant invention as recited.

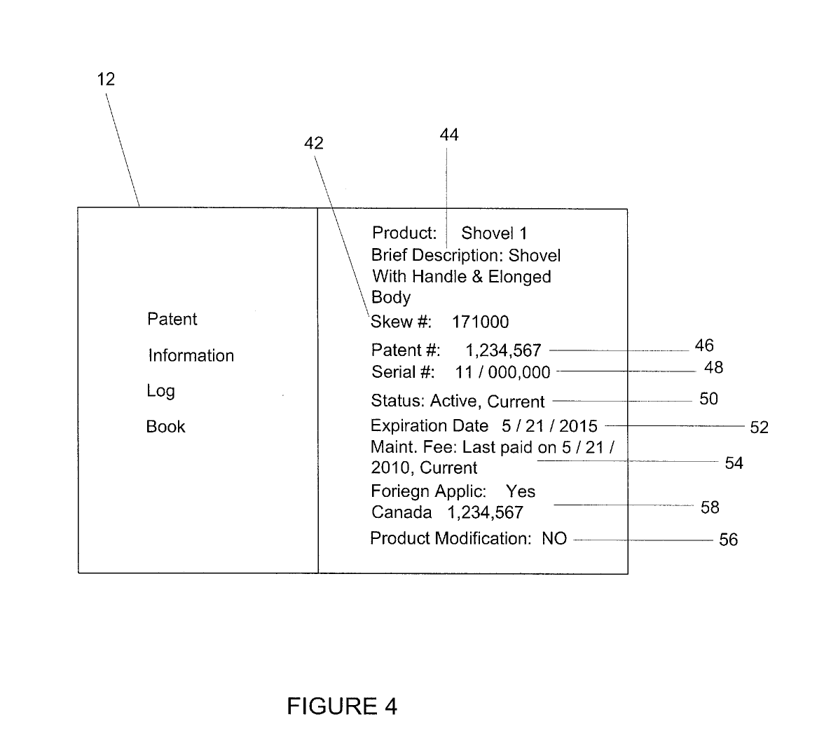

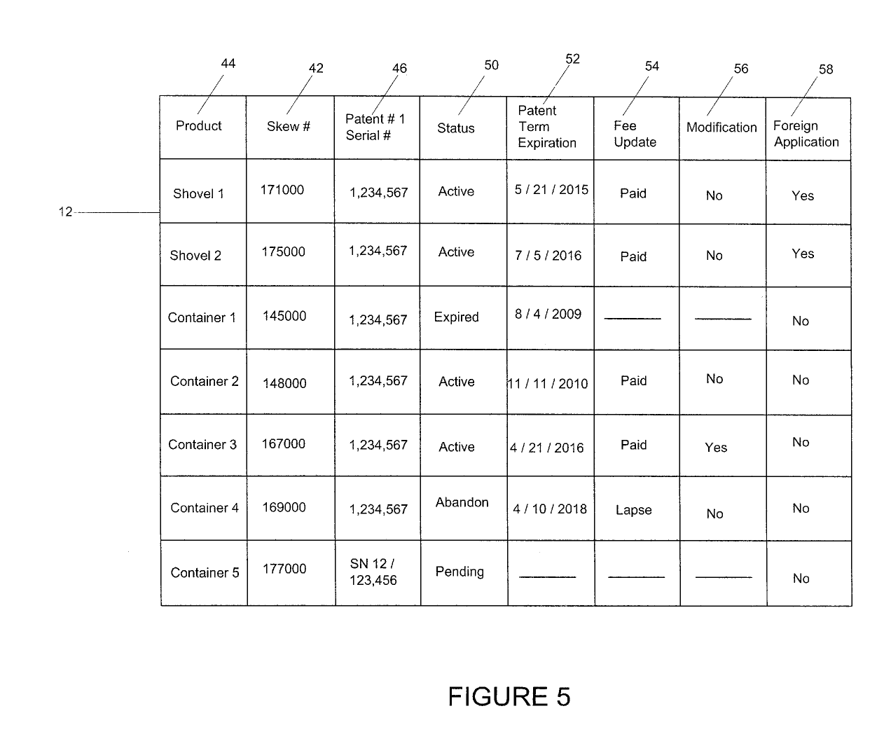

Identification of the product 30 can be accomplished manually, in which the user 28 is made aware of the product. For example, the user 28 may review a list of products to determine which products are to be manufactured and identifies all the products which require a determination and/or verification as to what intellectual property indicia should be printed, affixed, or connected to the commercial ready product 22. The user 28 enters the product 22 name or number into an intellectual property product search system 32 housed within the computer terminal 16. Once entered, the intellectual property product search system 32 accesses 34 and searches the databases 12 and/or 14 for a particular product 22. Upon accessing the databases, the intellectual property product search system 32 could return an exact hit and match for the product 22. A listing of a plurality of patent status-related data factors for the single match is displayed, in FIG. 4. The intellectual property product search system 32 may also be designed to return a list of possible matches, see FIG. 5. In the case where a list of possible matches is generated, the user 28 would review the data set and be instructed to select the product desired.

Alternatively, and particularly useful in automated systems, the product 22 may contain a unique company identification code. The product 22 is identified using a scanner device or bar code reader. Either prior to entering the manufacturing process or as part of the manufacturing process, the product 22 is scanned to reveal a unique product identification number, such as a skew number commonly used with commercial products. The intellectual property product search system 32 searches within the one or more databases 12 and/or 14 for the skew number associated with the product identification and a determination of which type of intellectual property indicia to be printed to the product can be assessed as the product is being manufactured.

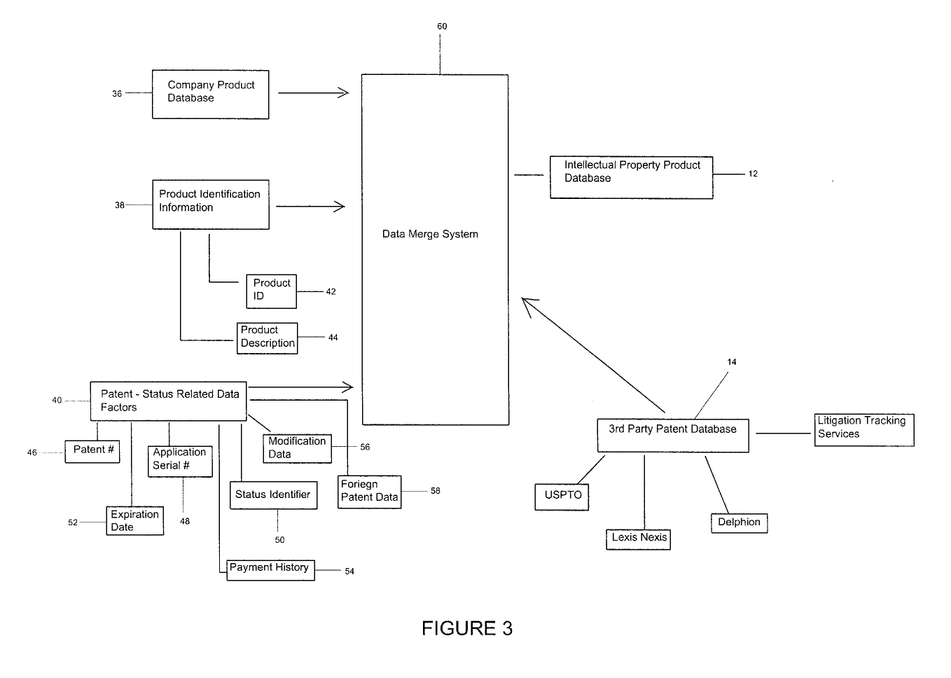

Once the product has been identified and the intellectual property information has been retrieved from the databases, the information regarding the product 22 can be analyzed using the computer generated software to determine what intellectual property indicia should be printed, affixed, or connected to the commercial ready product. While various databases exist which include patent related information, part of the operational aspect of the instant invention includes the steps of creating an intellectual property status-related product-specific database. Referring to FIG. 3, the database 12 is illustrated as a database relating specifically to a company's intellectual property portfolio. The database is created by identifying and listing all of the company's products which are associated with intellectual property, 36. The list may include products which are covered by one or more patents, copyrights, trademarks, and trade secrets. However, in a preferred embodiment, the database includes only products which are, or were once, covered by one or more patents or patent applications. The first database can be internally created by the user and include only patent information relating to the user's specific patent portfolio.

As an illustrative example, the database 12 contains information relating to a variety of patent status related factors. Each of these factors can be identified or analyzed as part of the process to determine the type of patent indicia required to be printed and placed on or associated with the product 22. The patent status related factors database should include product identification, such as a product identification number 42 and a product description 44 in order to provide a searchable database should the user 28 not be able to identify the product by other identifiers. If the product has, or had, a registered patent number, the patent number 46 should be included. If the product is in the prosecution stage, the patent number could be replaced by the application serial number 48. A status identifier 50, such as “active” or “non-active” or “pending” should be included to indicate if the patent is still in force. If the patent is non-active, additional identification such as “expired patent” or “abandoned patent” may be helpful. Such identifying tags can be useful in designing the software to execute instructions based on such tags. Information related to the expiration of the patent 52 is preferably part of the database. The information could be entered in as a single date, or alternatively as a software program which automatically determines the date, see for example the Maxval Patent Tool patent term calculator. Information relating to payment history 54, i.e. maintenance fee payment history, should also be a part of the database. Information relating to modifications 56 to the commercial product and/or the issued patent itself should be included in order to determine if the patented object is no longer covered by any of the original claims. Notation within the database could be made if the scope of the patent claims are modified post issuance, whether through reexamination or through litigation. In some cases, foreign filing information 58 may be desirable to be printed on the final product, and therefore would be beneficial to include such information as part of the database. All the patent related data factors can be merged into a single database using a data merge system 60.

Each of the patent categories 44-58 may include links to additional information. For example, as described previously regarding the “information categories,” a second page of information may be accessed by clicking on the individual category header. Such page may simply be a pure text page which lists further information relating to the specific subject. Referring to FIG. 5, by clicking on “Shovel 1” under category 44, the user 28 may be directed to a second page which gives a more detailed description as to the make up of the shovel, and perhaps a listing of any patent claims that may cover the product. Clicking on the “Skew Number” under category 42, the user 28 is directed to information about that product, such as when the product was manufactured, where the product is scheduled to be delivered to, or other commercially relevant information which may be required. In an alternative embodiment, the first database is linked to a second database. The second database is preferably a database operated by an independent, third party which is not associated with user 28. For example, the second database could include the United States Patent & Trademark Office Patent database, or the patent database network owned by DELPHION.

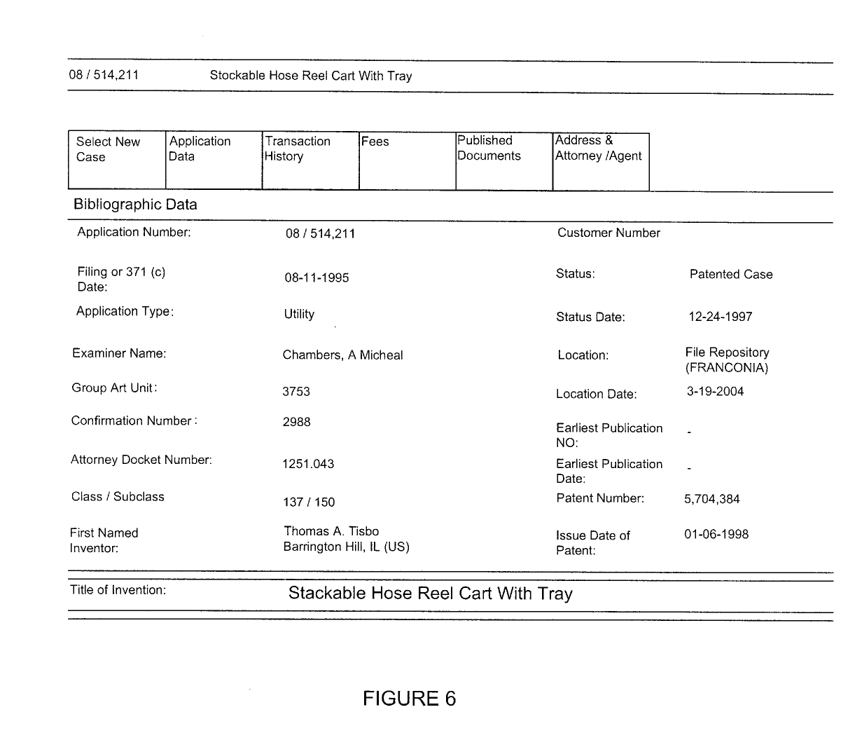

Should the user 28 click on the “Status” category, the computer implemented software program could be used to access the U.S. Patent Office database either through use of Public Pair or through the use of Private Pair. Once accessed, the user 28 would be linked to real time information relating to the patent status, such as the bibliographic data page, see FIG. 6. The computer implemented software can be programmed to identify the various terms on the page and respond accordingly. Additionally, the program can be used to verifying the data and confirm the patent is a “patented case,” thus assuring that the patent indicia that may be ultimately printed and associated with the commercial product will not subject the user 28 to false marking allegations.

FIG. 6 illustrates a Patent Bibliographic Data from the USPTO website relating to the payment of maintenance fees which can be obtained by user 28 clicking on the payment history 54 of the database. By linking to such a page, the user 28, either manually, or through computer implemented software, can determine if the patent is current, i.e. the fees have been maintained, or whether the patent has been abandoned and no longer enforceable as a result of lack of payment. Information regarding payment history can then be retrieved from the USPTO website and placed in the database 12. Since certain types of patent indicia should not be placed onto the patent if the patent is not longer enforceable, information relating to payment fees is vital. Should the patent holder fail to pay the maintenance fees at any of the required times, i.e. by the 4^{th} year, 8^{th} year, or 12^{th} year, no patent related indicia indicating that the object is patented would be printed.

Referring back to FIG. 2, to determine what intellectual property information should be printed upon a product, once the product has been identified, the one or more databases which store the intellectual property status-determining factors is accessed 34, either manually or through the use of computer implemented software. The software program can be designed to properly identify the user 28, preferably though use of security features such as passwords and user identification, prior to access to the first database, the second, third party database, or combinations thereof. Once the database has been accessed, the intellectual property information stored within is retrieved 64, reviewed, and analyzed by the computer readable software program used by the computer terminal 16. The information retrieved is analyzed and compared using the computer driven software to analyze the various categories or tags in an effort to provide the user 28 with a systematic method to determine what, if any, type of intellectual property information should be affixed to or associated with the product, see box 66.

In an illustrative example of the operational aspects of the system 10, to determine if a product should include patent marking related indicia, the computer implemented software can be designed to review and analyze several factors. First, the analysis begins with a determination of whether the product is covered by patents, 70. If the product is covered by a patent or includes sub-combinations which are covered by a patent, the software program can be designed to verify several additional features before printing the patent number. For example, to ensure that the product 22 does not subject the patent owner to false marking allegations, the status of the patent 72 should be observed by verifying that the patent has not been abandoned. For those patents that have been abandoned, a patent number is not printed on the product. For patents that have not been abandoned, the term of the patent must be verified 74. Verification can be accomplished by either including the patent expiration date as part of the database or by using programs that computes the date based on data input. In either case, the computer generated software program can compare the current date against the expiration date and be programmed to print the desired patent indicia should the patent contain current patent term. Should the printing date be a time in which the patent term has expired, a “no print” instruction 76 will be issued and the product will not include patent indicia.

If, however, the patent is still in force, the computer implemented software can check other factors prior to printing. For example, the status of the maintenance fees must be verified, 78. For patents in which any of the maintenance fees have not been paid, the patent number is not printed, 80. A notification may be sent to the user 28 indicating that the maintenance fees have not been paid. This notification provides warning to the user 28 and can provide a valuable tool to maintain patent protection in situations in which the fees were unintentionally not paid. If the fees have been paid, the analysis continues to the step of determining if the patent or the product has been modified. If the patent has been modified, either through reexamination or litigation, such that the modifications results in the product 22 no longer being covered by the patent, a “no print” 84 instruction will be issued and the product will not be labeled with patent indicia 20. If the product itself has been modified in any manner such that it is no longer covered by the original or modified patent, a “no print” 84 instruction will be issued and the product will not be labeled with patent indicia 20. Once all factors have been analyzed and a determination has been made to print, 86 the software program instructs the printing device 18 to print the patent indicia 20. In addition to the U.S. patent indicia, should the product be covered by other foreign patents which are enforceable, the software program will scan the database and find eligible foreign patent indicia to print 86 as well. While the patent indicia can be printed to the product or a label prior to the entry of the product within the channels of commerce, the preferred embodiment includes printing intellectual property indicia at the time of manufacture.

For products which are not covered by an issued patent, the software program can be used to verify the status of prosecution, 90. If the product is not subject to a patent application, a “no print” instruction 92 is issued. If the patent is subject to a patent application, the computer verifies its status to determine the print instruction. For example, if the patent has been abandoned 96 as a result of failure to reply to an office action, “patent pending” is not printed onto the product 22. As described before, a notification may be sent to the patent owner, indicating that the patent prosecution has been terminated. If the patent application is currently pending, printer 18 is instructed to print a “patent pending” label. The database 12 or 14 which houses this information may be updated, either through manual manipulation of the data or through access to current databases which house such information. By regularly accessing a third party database 14, i.e. USPTO website, applications with serial numbers which were unintentionally abandoned and revived would be instructed to print patent indicia upon changes in status. Such information may additionally be uploaded to the first database, thereby updating its status in that database as well.

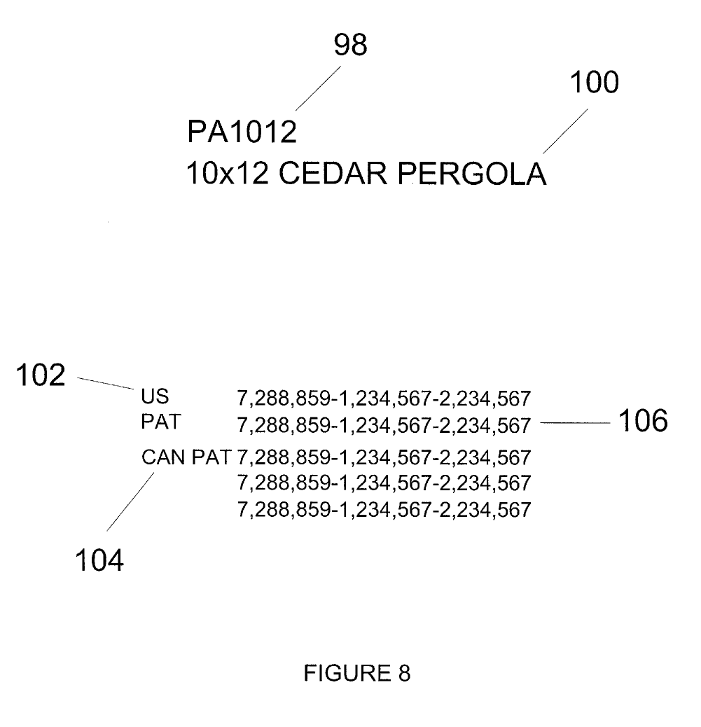

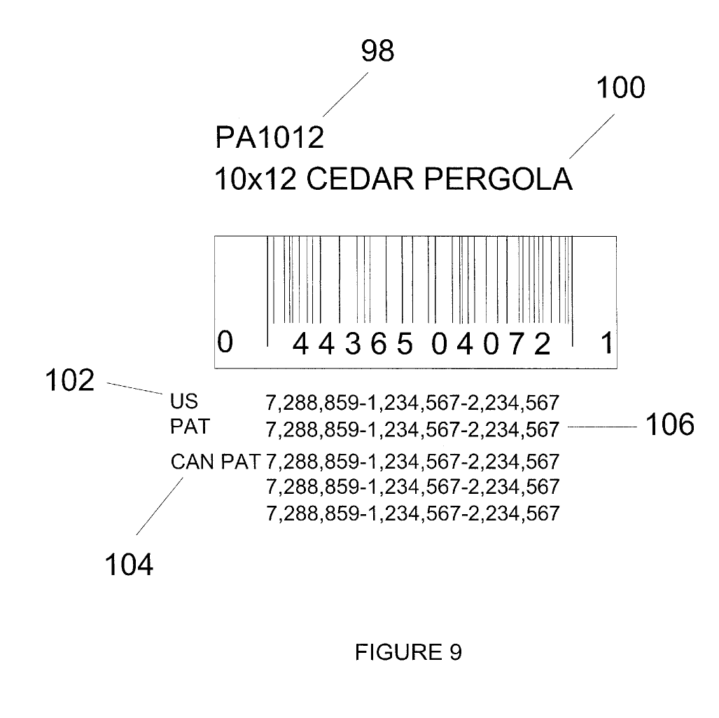

Upon a final determination that the product should include patent indicia, such patent indicia can be printed using mechanisms known to one of skill in the art. FIG. 8 is an illustrative example of printed patent indicia, and includes product identification number 98, brief description 100, and a listing of U.S patent numbers 102 and foreign patent numbers 104. FIG. 9 illustrates an alternative example of the printed patent indicia, including product identification number 98, brief description 100, a listing of U.S patent numbers 102, and a listing of foreign patent numbers 104, in combination with an optical machine-readable representation of data, illustrated herein as a bar code 106, such as a universal product code (UPC). In addition to providing information about the product, the use of the bar code 106 allows the company the ability to monitor the patent marking status of the marked item. For instance, should the product that contains a patent marking remain stored in a warehouse prior to shipping for an extended period of time in which the status of the patent changes, the company maintains a mechanism which minimizes the chance of a false marking claim by adding a verification step 110, see FIG. 2. The verification step 110 verifies the status of the products upon leaving the manufacturing process site. Prior to the stored merchandise shipping to a commercial vender, the company could scan the bar code and determine if the product's intellectual property indicia may require modifications by accessing the databases and performing the analysis steps described previously.

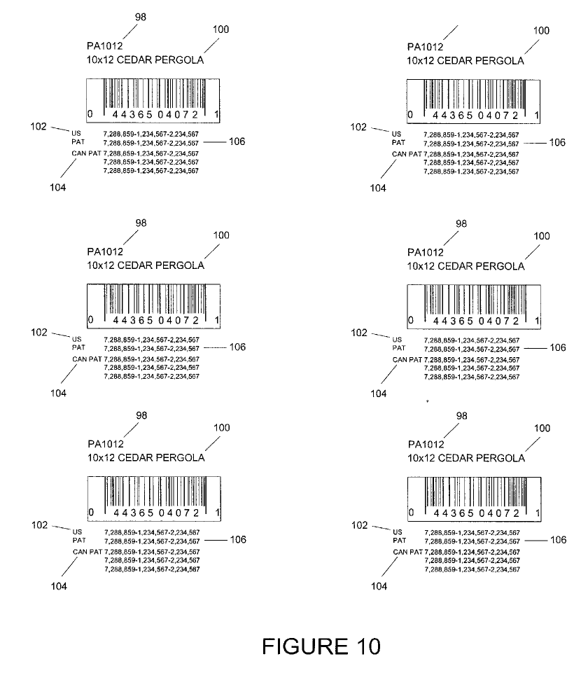

Once the intellectual property indicia has been printed, it is then affixed to or associated with, the commercial ready product, 108. While the intellectual property marking indicia can be printed directly onto the product, through the use of, for example, laser etching mechanisms or die castings with the patent number, the intellectual property indicia may be indirectly attached by use of an attachable label, see FIG. 10, or as part of the products packaging. The printed labels can be produced and applied to the product, manually or automatically, when the product is ready for manufacture or for shipment. In situations in which the labeled products remain housed in a warehouse for an extended period of time, the product can be identified prior to final shipment by having the computer terminal 18 run through the steps outlined above to verify that the product should be shipped with the current patent indicia. If for some reason the product requires a modification to the patent labeling, a new label could be printed. In this manner, the user 28 can be assured that any patent marking placed upon the commercial object does not subject the patent owner to a 35 U.S.C. 292 false marking allegation, reduces its litigation exposure, and reduces its costs to fix the problem.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method for determining the type of intellectual property indicia to be printed onto a commercial ready product prior to entry of the product within the channels of commerce, comprising the steps of
obtaining a commercial ready product which requires a determination if one or more intellectual property indicia should be affixed thereupon;
retrieving intellectual property information regarding said commercial ready product from at least one database, said database housing one or more factors related to said commercial ready product intellectual property status;
determining what intellectual property indicia should be printed and affixed to said commercial ready product,
printing said intellectual property indicia relating to said commercial ready product, and
affixing, associating, or combinations thereof, said printed intellectual property indicia to said commercial ready product, whereby said method for determining the type of intellectual property indicia to be printed onto a commercial ready product prior to entry of said product within the channels of commerce minimizes the risks associated with marking said commercial ready product with said intellectual property indicia.

2. The method for determining the type of intellectual property indicia to be printed onto a commercial ready product prior to entry of the product within the channels of commerce according to claim 1 wherein said intellectual property information stored in said at least one database and said intellectual property indicia is patent related, whereby said method minimizes the risks associated with the marking requirements under the United States Patent laws.

3. The method for determining the type of intellectual property indicia to be printed onto a commercial ready product prior to entry of the product within the channels of commerce according to claim 2 wherein said patent related intellectual property indicia is a corresponding patent number.

4. The method for determining the type of intellectual property indicia to be printed onto a commercial ready product prior to entry of the product within the channels of commerce according to claim 2 wherein said step of printing said intellectual property indicia relating to said commercial ready product includes product identification in combination with said corresponding intellectual property indicia.

5. The method for determining the type of intellectual property indicia to be printed onto a commercial ready product prior to entry of the product within the channels of commerce according to claim 4 wherein said product identification is included in the form of optical machine-readable representation of data.

6. A method for determining the type of intellectual property indicia to be printed onto a commercial ready product prior to entry of the product within the channels of commerce, comprising the steps of:
creating at least one database containing intellectual property information effective for determining the type of intellectual property indicia which may be required to be affixed to or associated with one or more commercial ready products prior to entering the channels of commerce;
coupling said at least one database to at least one programmable device that receives, stores, manipulates, and outputs data;
identifying one or more commercial ready products which requires a determination if one or more intellectual property indicia should be affixed thereupon;
retrieving said intellectual property information regarding said commercial ready product from said at least one database;
determining what intellectual property indicia should be printed, affixed, or connected to said commercial ready product, said determination including a computer generated software analysis of said intellectual property information stored in said at least one database;
printing said intellectual property indicia to said commercial ready product, and
affixing, associating, or combinations thereof, said printed intellectual property indicia to said commercial ready product;
whereby said method for determining the type of intellectual property indicia to be printed onto a commercial ready product prior to entry of the product within the channels of commerce minimizes the risks associated with marking said commercial ready product with said intellectual property indicia.

7. The method for determining the type of intellectual property indicia to be printed onto a commercial ready product prior to entry of the product within the channels of commerce according to claim 6 wherein said at least one database contains one or more patent status related factors.

8. The method for determining the type of intellectual property indicia to be printed onto a commercial ready product prior to entry of the product within the channels of commerce according to claim 7 wherein said patent status related factors includes, a product identification number, a product identification description, patent numbers associated with said commercial ready product, patent application serial number, patent status information, patent application status information, date of patent term expiration, maintenance fee history, patent modification data, commercial product modification data, litigation data, or combinations thererof.

9. The method for determining the type of intellectual property indicia to be printed onto a commercial ready product prior to entry of the product within the channels of commerce according to claim 6 wherein said at least one database is an internal database, said internal database housing information regarding an intellectual property portfolio relating to a specific intellectual property holder.

10. The method for determining the type of intellectual property indicia to be printed onto a commercial ready product prior to entry of the product within the channels of commerce according to claim 6 wherein said at least one database is created by and/or operated by a third party, said third party database housing information regarding an intellectual property portfolio related to a plurality of intellectual property holders.

11. The method for determining the type of intellectual property indicia to be printed onto a commercial ready product prior to entry of the product within the channels of commerce according to claim 6 wherein said intellectual property information is retrieved from a first internal database which stores information relating to specific intellectual property holder, a second database operated by a third party that includes intellectual property information relating to a plurality of intellectual property holders, or combinations thereof.

12. The method for determining the type of intellectual property indicia to be printed onto a commercial ready product prior to entry of the product within the channels of commerce according to claim 11 wherein said at least one database includes the United States Patent & Trademark Office patent database.

13. The method for determining the type of intellectual property indicia to be printed onto a commercial ready product prior to entry of the product within the channels of commerce according to claim 11 wherein said first database and said second database are electronically coupled.

14. The method for determining the type of intellectual property indicia to be printed onto a commercial ready product prior to entry of the product within the channels of commerce according to claim 6 further including the step of verifying that said commercial ready products which have entered said channels of business properly contain said printed intellectual property indicia which has been affixed or associated to thereto.

15. The method for determining the type of intellectual property indicia to be printed onto a commercial ready product prior to entry of the product within the channels of commerce according to claim 6 wherein the step of printing includes printing said intellectual property indicia to a label.

16. The method for determining the type of intellectual property indicia to be printed onto a commercial ready product prior to entry of the product within the channels of commerce according to claim 6 wherein the step of affixing, associating, or combinations thereof, said printed intellectual property indicia to said commercial ready product includes direct attachment to said product.

17. The method for determining the type of intellectual property indicia to be printed onto a commercial ready product prior to entry of the product within the channels of commerce according to claim 6 wherein the step of affixing, associating, or combinations thereof, said printed intellectual property indicia to said commercial ready product includes indirect attachment.

18. The method for determining the type of intellectual property indicia to be printed onto a commercial ready product prior to entry of the product within the channels of commerce according to claim 6 wherein said patent related intellectual property indicia is a corresponding patent number.

19. The method for determining the type of intellectual property indicia to be printed onto a commercial ready product prior to entry of the product within the channels of commerce according to claim 18 wherein said intellectual property indicia relating to said commercial ready product includes product identification in combination with said corresponding patent number.

20. The method for determining the type of intellectual property indicia to be printed onto a commercial ready product prior to entry of the product within the channels of commerce according to claim 19 wherein said product identification is included in an optical machine-readable representation of data.

21. A system for determining the type of intellectual property indicia to be printed onto a commercial ready product prior to entry of the product within the channels of commerce, comprising:
a first database containing one or more intellectual property status related data factors associated with one or more commercial ready products;
at least one programmable device that receives, stores, manipulates, and outputs data, said at least one programmable device being coupled with said first database, said programmable device capable of accessing said first database and retrieving said intellectual property information relating to one or more commercial ready products,
said at least one programmable device further containing a computer executable software having a code stored on a readable medium operable with said first database, said software for processing said intellectual property information in a particular manner and determining what intellectual property indicia should be printed and associated with one or more commercial ready products prior to said products entering the channels of commerce, and
a printer, said printer in operable connection with said at least one programmable device and capable of receiving and processing a command from said software for processing said intellectual property information in a particular manner to print said intellectual property indicia related to one or more commercial ready products,
whereby said system for determining the type of intellectual property indicia to be printed onto a commercial ready product prior to entry of said product within the channels of commerce minimizes the risks associated with marking said commercial ready product with said intellectual property indicia.

22. The system for determining the type of intellectual property indicia to be printed onto a commercial ready product prior to entry of the product within the channels of commerce according to claim 21 wherein said first database is an internal database, said internal database housing information regarding the intellectual property portfolio related to a specific intellectual property holder.

23. The system for determining the type of intellectual property indicia to be printed onto a commercial ready product prior to entry of the product within the channels of commerce according to claim 21 wherein said first database is an external database created and operated by a third party, said third party database housing information relating to the intellectual property portfolio related to a plurality of intellectual property holders.

24. The system for determining the type of intellectual property indicia to be printed onto a commercial ready product prior to entry of the product within the channels of commerce according to claim 21 further including a second database coupled to said first database and said programmable device, said second database created and operated by a third party and housing the intellectual property information relating to a plurality of intellectual property holders.

25. The system for determining the type of intellectual property indicia to be printed onto a commercial ready product prior to entry of the product within the channels of commerce according to claim 21 wherein said intellectual property status related data factors are related to patents.
